(19) United States
(12) Patent Application Publication
(10) Pub. No.: US 2010/0098976 A1
(43) Pub. Date: Apr. 22, 2010

(54) FUEL CELL SYSTEM AND METHOD FOR CHECKING FOR HYDROGEN LEAKAGE IN FUEL CELLS THEREOF

(75) Inventors: Chien-Ping Yeh, Taoyuan County (TW); Yu-Chun Ko, Taoyuan County (TW); Chiang-Wen Lai, Taoyuan County (TW)

Correspondence Address: QUINTERO LAW OFFICE, PC, 615 Hampton Dr, Suite A202, Venice, CA, 90291, US

(73) Assignee: NAN YA PCB CORP., Taoyuan County (TW)

(21) Appl. No.: 12/408,983

(22) Filed: Mar. 23, 2009

(30) Foreign Application Priority Data
Oct. 20, 2008 (TW) TW097140156

(51) Int. Cl. H01M 8/00; H01M 8/04

(52) U.S. Cl. 429/13; 429/23

(57) ABSTRACT

A fuel cell system and a method for checking for hydrogen leakage are provided. The fuel cell system includes a fuel cell module having at least one fuel cell. The fuel cell system further includes a valve coupled to the fuel cell module and a hydrogen source for allowing hydrogen to be passed to the fuel cell module or blocking hydrogen from being passed to the fuel cell module. The fuel cell system further includes a controller board coupled to the valve and the fuel cell module for checking output voltage of the at least one fuel cell to determine whether there is hydrogen leak. The control board controls the valve for blocking hydrogen from being passed to the fuel cell module when the control board determines that there is a hydrogen leak.

### CROSS REFERENCE TO RELATED APPLICATION

This Application claims priority of Taiwan Patent Application No. 97140156, filed on Oct. 20, 2008, the entirety of which is incorporated by reference herein.

### BACKGROUND OF THE INVENTION

1. Field of the Invention

The present invention relates to a fuel cell system, and in particular relates to a fuel cell system and method for checking for hydrogen leakage in fuel cells thereof.

2. Description of the Related Art

Recently, fuel cells have been applied to a variety of fields such as generator modules, internal combustion engines and portable electronic communication products, due to their high transformation efficiency and low pollution etc. However, hydrogen fuel cells are inflammable, explosive and highly heat conductive, therefore, making hydrogen leakage extremely dangerous for hydrogen fuel cells. Hydrogen leakage may occur due to a damaged proton film in a fuel cell. Specifically, due to the damaged proton film, hydrogen molecules in the anode of the fuel cell pass through the damaged proton film to the cathode to be catalyzed by a catalyzer, and then hydrogen molecules react with oxygen, causing heat or fire. Additionally, due to the damaged proton file, output voltage of fuel cells thereof will decrease.

A conventional method for detecting hydrogen leakage in fuel cells is to externally connect a hydrogen detector to a fuel cell module to sense hydrogen concentration of the fuel cell module. However, for portable electronic products, a hydrogen detector increases volume. Additionally, integration of a hydrogen detector in portable electrical products is inconvenient.

To solve the abovementioned problem, it is necessary to provide a fuel cell system having advantages of checking for hydrogen leakage and being easily integrated into portable electronic products.

### BRIEF SUMMARY OF INVENTION

A detailed description is given in the following embodiments with reference to the accompanying drawings.

In one aspect, the present invention provides a fuel cell system. The fuel cell system comprises: a fuel cell module having at least one fuel cell; a valve coupled to the fuel cell module and a hydrogen source for allowing hydrogen to be passed to the fuel cell module or blocking hydrogen from being passed to the fuel cell module; and a controller board coupled to the valve and the fuel cell module for checking output voltage of the at least one fuel cell to determine whether there is a hydrogen leak; wherein the control board controls the valve for blocking hydrogen from being passed to the fuel cell module when the control board determines that there is a hydrogen leak.

In another aspect, the present invention provides a method for checking for hydrogen leakage in fuel cells. The method comprises the steps of: providing a fuel cell module, wherein the fuel cell module has at least one fuel cell; removing the fuel cell from a load or loads; obtaining respective output voltages of at least one fuel cell in the fuel cell module; comparing the respective output voltages of the at least one fuel cell with a predetermined voltage; and determining that there is a hydrogen leak when one of the output voltages of the at least one fuel cell is lower than the predetermined voltage.

The abovementioned fuel cell system and method for checking for hydrogen leakage in fuel cells is capable of being integrated into common or conventional fuel cell systems without increasing volume by means of utilizing a circuitry system to detect fuel cell voltages.

### BRIEF DESCRIPTION OF DRAWINGS

The present invention can be more fully understood by reading the subsequent detailed description and examples with references made to the accompanying drawings, wherein:

FIG. 1 is a diagram showing the structure of a fuel cell system of the present invention;

FIG. 2 is a flowchart illustrating the method for checking for hydrogen leakage according to an embodiment of the present invention;

FIG. 3 is a exemplary diagram of a fuel cell module of the present invention; and

FIG. 4 is a flowchart illustrating another method for checking for hydrogen leakage according to an embodiment of the present invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

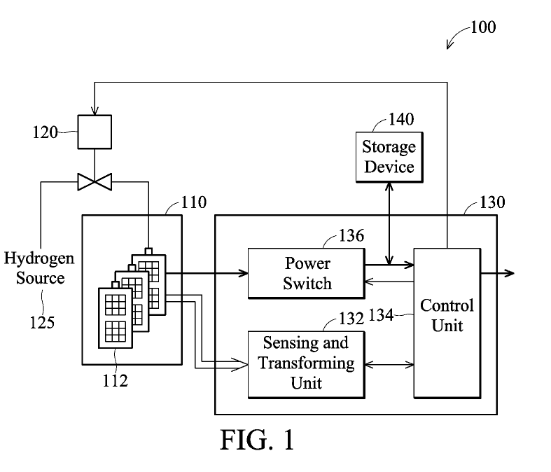

FIG. 1 is a diagram showing the structure of a fuel cell system of the present invention. The fuel cell system includes a fuel cell module 110, a valve 120, a control board 130 and a storage device 140.

The fuel cell module 110 has at least one fuel cell 112, and each fuel cell has an output voltage. The amount of the fuel cells may vary according to load requirements of a fuel cell system. Generally, utilizing a plurality of fuel cells with identical standard connected in series is preferred to raise output voltage of the fuel cell module 110. In another embodiment, the fuel cell module 110 may comprise many groups of fuel cells connected in series and connected in parallel. The valve 120 is an ON/OFF switch which is coupled to the fuel cell module 110 and a hydrogen source for allowing hydrogen to be passed to the fuel cell module 110 or blocking hydrogen from being passed to the fuel cell module 110. The control board 130 is coupled to the fuel cell module 110 and the valve 120. The control board 130 checks output voltage of the fuel cell module 110 and output voltages of the at least one fuel cell to determine whether there is a hydrogen leak. If so, the control board will issue a control signal to the valve 120. A storage device 140 such as lithium batteries, NiMH batteries and super capacitors etc., is used to temporarily providing power to the control board 130.

The control board 130 may have an independent circuitry being capable of receiving, processing and sending various signals. The control board 130 may also include several integrated units. According to an embodiment of the present invention, the control board 130 further includes a sensing and transforming unit 132, a control unit 134 and a power switch 136. The sensing and transforming unit 132 is used for detecting terminal voltages of the at least one fuel cell connected in series or output voltage of the fuel cell module 110. The control unit 134 such as microprocessors, microcontrollers, single chips and digital signal processors etc., will proceed to process, analyze and perform calculation according to the received signals. According to an embodiment of the present invention, the control unit 134 will derive the respective output voltages of the at least fuel cell 112 from the digital signals of the terminal voltages of the at least one fuel cell 112 connected in series, and then compare the respective output voltages of the at least one fuel cell 112 with a predetermined voltage value to determine whether the output voltages are dropping off. Note that output voltages herein represent open circuit voltage when the at least one fuel cell 120 are not connect to any load. Also, the predetermined voltage value may be set by users according to fuel cell application. For instance, if output voltage of a normal fuel cell unit is 0.6V to 0.9V, then a predetermined voltage value may be set at 0.5V. Therefore, when the output voltage of one fuel cell decreases to the predetermined voltage value 0.5V, it is determined that there is a hydrogen leak. Following, the control unit 134 issues a signal to the valve 120 such that the valve 120 can block hydrogen from entering the fuel cell module 110. Similarly, the control unit 134 will also compare output voltage of the fuel cell module 110 with a predetermined operation voltage. Note that output voltage herein represents measured voltage when the fuel cell module 110 is connected to a load or loads. The predetermined operation voltage is the lowest voltage which loads connected to a system can be operated. When output voltage of the fuel cell module 110 is lower than the predetermined operation voltage, the control board determines that there is a hydrogen leak. At the same time, the control unit 134 will send a signal to the valve 120 so that the valve 120 closes.

The storage device 140 is coupled to the control board 130 to temporarily supply power to the control board 130 before the fuel cell module 110 provides power to the control board 130. The power switch 136 is substantially an ON/OFF switch installed in the control board 130, which is coupled to the control unit 134. The power switch 136 is used for allowing power to flow to or blocking power from flowing to the control board 130. When the fuel cell module 110 is coupled to a load or loads the power switch is opened to allow power of the fuel cell module 110 to be delivered to the control board 130 and to charge the storage device 140.

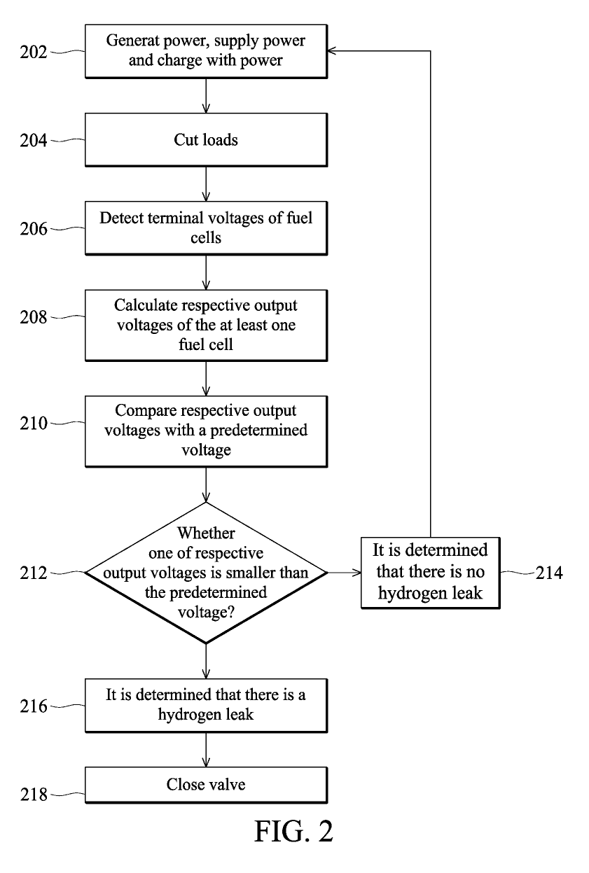

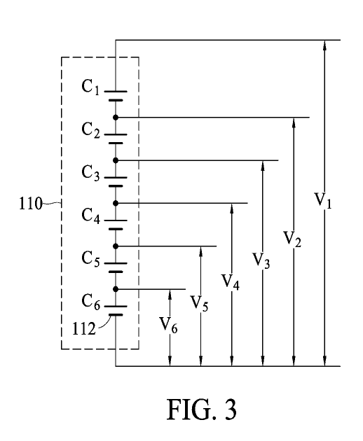

FIG. 2 is a flowchart illustrating a method for checking for hydrogen leakage according to an embodiment of the present invention. At step 202, the hydrogen enters into the fuel cell modules 110 such that the fuel cell module 110 begins to generate power and following, provides power to the control board 130 to start up peripheral device and charge the storage device 140. Next, at step 204 the control unit 134 inside of the control board 130 directs the power switch 136 to be closed, wherein connection between the fuel cell module 110 and the control board 130 is cut, or the fuel cell module 110 is block from connecting to other loads such that the fuel cell module is an open circuit. At step 206, the sensing and transforming unit 132 of the control board 130 detects terminal voltages of the at least one fuel cell. The fuel cell module 110 is usually made up of at least one fuel cell with identical standards connected in series. Consequently, there may be a plurality of terminal voltages in the module 110 as shown in FIG. 3. The sensing and transforming unit 132 transforms terminal voltages of the at least one fuel cell 112 into digital terminal voltage signals and then sends the digital terminal voltage signals to the control unit 134. After, in step 208, the control unit 134 of the control board 130 calculates current output voltage values of the at least one fuel cell 112 according to the digital terminal voltage signals.

FIG. 3 is an exemplary diagram of a fuel cell module of the present invention. The exemplary diagram describes the method for calculating output voltages of the at least one fuel cell 112. As FIG. 3 shows, the fuel cell module 110 includes six fuel cells 112 (C1-C6) connected in series, hence there are six terminal voltages V1, V2 . . . V6. The control unit 134 receives digital signals of V1, V2 . . . V6, and then subtracts V2 from V1 to get the output voltage of the fuel cell C1, subtracts Vₙ₊₁ from Vₙ to get the output voltage of the fuel cell Cₙ, and so forth.

At step 210, the control unit 134 compares each output voltage of the at least one fuel cell 112 with a predetermined voltage. If one output voltage of the at least one fuel cell 112 is smaller than the predetermined voltage, then it is determined that there is hydrogen leak. Therefore, the control unit 134 will issue a signal to close the valve 120 to block hydrogen from being transmitted. Thus, ending the method at step 218. If each output voltage of the at least one fuel cell 112 is larger than the predetermined voltage, then it is determined that there is a hydrogen leak for the at least one fuel cell 112. Therefore, the steps return to step 202. The control board 130 again opens the power switch 136 and connects the fuel cell module 110 back to a load or loads. The fuel cell module 110 supplies power to the control board 130 or loads and charges the storage device 140. Following, the steps are repeated as described.

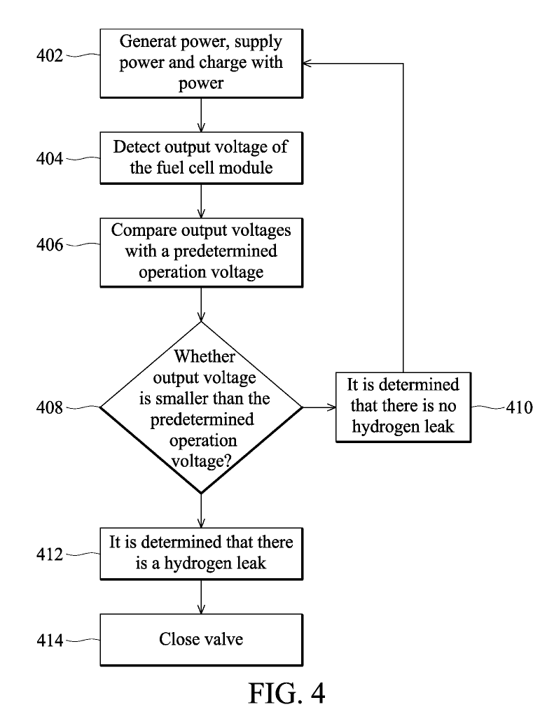

FIG. 4 is a flowchart illustrating another method for checking for hydrogen leakage according to an embodiment of the present invention. At step 402, the hydrogen enters into the fuel cell modules 110 such that the fuel cell module 110 can begins to generate and then provide generated power to the control board 130 to start up peripheral devices and charge the storage device 140. Next, at step 404, the sensing and transforming unit 132 of the control board 130 detects output voltage of the fuel cell module 110 and transforms output voltage to digital output voltage signal. At step 406, the control unit 134 compares output voltage of the fuel cell module 110 with a predetermined operation voltage. As those skilled in the art know, when the fuel cell module 110 connects to a load, output voltage of the fuel cell module will decrease. However, when output voltage drops to a voltage level that can cause a load not to operate properly, a hydrogen leak may be present. The predetermined operation voltage value is determined according to a hydrogen lead voltage dropping range. At step 412, if output voltage of the fuel cell module 110 is smaller than the predetermined operation voltage, then at least one fuel cell is determined to contain a hydrogen leak. Therefore, at step 414, the control unit 134 will send a signal to close the valve 120 to block hydrogen from being transmitted. At step 410, if output voltage of the fuel cell module 110 is larger than the predetermined operation voltage, then it is determined that there is no hydrogen leak for the at least fuel cell 112, thereof, the steps return to step 402. Following, the steps are repeated as described.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell system, comprising:
a fuel cell module, having at least one fuel cell;
a valve, coupled to the fuel cell module and a hydrogen source for allowing hydrogen to be passed to the fuel cell module or blocking hydrogen from being passed to the fuel cell module; and
a controller board, coupled to the valve and the fuel cell module for checking output voltage of the at least one fuel cell to determine whether there is a hydrogen leak;
wherein the control board controls the valve for blocking hydrogen from being passed to the fuel cell module when the control board determines that there is a hydrogen leak.

2. The fuel cell system as claimed in claim 1, wherein the fuel cell module is made up of a plurality of the at least one fuel cell connected in series.

3. The fuel cell system as claimed in claim 2, wherein the control board derives respective output voltages of the at least one fuel cell according to terminal voltages produced by the at least one fuel cell.

4. The fuel cell system as claimed in claim 3, wherein the control board compares respective output voltages of the at least one fuel cell with a predetermined voltage, and when one of output voltages of the at least one fuel cell is lower than the predetermined voltage, the control board determines that there is a hydrogen leak.

5. The fuel cell system as claimed in claim 2, wherein the control board further comprises:
a sensing and transforming unit for transforming terminal voltages of the at least one fuel cell into digital terminal voltage signals; and
a control unit coupled to the sensing and transforming unit for deriving digital output voltage signals from digital terminal voltage signals, and comparing the respective digital output voltage signals with a predetermined voltage value, wherein when one of digital output voltage signals of the at least one fuel cell is lower than the predetermined voltage value, the control board determines that there is a hydrogen leak.

6. The fuel cell system as claimed in claim 1, wherein the control board checks output voltage of the fuel cell module to determine whether hydrogen is leaking out when the fuel cell module couples to a load.

7. The fuel cell system as claimed in claim 6, wherein the control board compares output voltage of the fuel cell module with a predetermined operation voltage, and when output voltage is lower than the predetermined operation voltage, the control board determines that there is a hydrogen leak.

8. The fuel cell system as claimed in claim 1, wherein the fuel cell system further comprises a storage device coupled to the control board for providing power to the control board when the fuel cell module is not coupled to a load.

9. The fuel cell system as claimed in claim 8, wherein the control board further comprises:
a power switch for allowing power to pass to the control board or blocking the power from being passed to the control board; and
a control unit coupled to the power switch for opening the power switch and allowing power to pass to the control board such that the fuel cell module provides the control board with power and charges the storage device with power.

10. A method for checking for hydrogen leakage in fuel cells, comprising:
providing a fuel cell module, wherein the fuel cell module has at least one fuel cell;
removing the fuel cell module from a load or loads;
obtaining respective output voltages of the at least one fuel cell in the fuel cell module;
comparing the respective output voltages of the at least one fuel cell with a predetermined voltage; and
determining that there is a hydrogen leak if the output voltages of the at least one fuel cell is lower than the predetermined voltage.

11. The method as claimed in claim 10, further comprising:
coupling the fuel cell module to a load;
detecting output voltage of the fuel cell module;
comparing output voltage of the fuel cell module with a predetermined operation voltage and
determining that there is a hydrogen leak when output voltage of the fuel cell module is lower than the predetermined operation voltage.

12. The method as claimed in claim 10 or claim 11, further comprising:
blocking hydrogen from being passed to the fuel cell module when it is determined that there is a hydrogen leak.

13. The method as claimed in claim 10, wherein the obtaining respective output voltages of the at least one fuel cell in the fuel cell module comprises:
measuring terminal voltages of the at least one fuel cell connected in series;
calculating respective output voltages of the at least one fuel cell according to terminal voltages of the at least one fuel cell.
